(19) United States
(12) Patent Application Publication
(10) Pub. No.: US 2019/0278570 A1
(43) Pub. Date: Sep. 12, 2019

(54) Annotating Features of a Resource to Facilitate Consumption in Different Computing Environments

(71) Applicant: Microsoft Technology Licensing, LLC, Redmond, WA (US)

(72) Inventors: Bart Johan Fred DE SMET, Bellevue, WA (US); Eric Anthony ROZELL, Greenfield Center, NY (US); Alexander Paul CLEMMER, Bellevue, WA (US)

(21) Appl. No.: 15/916,014

(22) Filed: Mar. 8, 2018

(51) Int. Cl. G06F 8/35; G06F 8/38; G06F 8/77

(52) U.S. Cl. CPC G06F 8/35; G06F 8/77; G06F 8/38

(57) ABSTRACT

A technique is described herein for facilitating a client's interaction with a machine-consumable resource, such as, but not limited to, a database, a service (or microservice), user interface-related information used to construct a consumer-side user interface presentation, etc. The technique includes a definition phase and a consummation phase. In the definition phase, the technique can produce different sets of attributes. Each set of attributes complements a particular target consumption environment. In the consumption phase, the technique determines the characteristics of the consumption environment that a consumer is currently using. The technique then retrieves an appropriate set (or sets) of attributes associated with that consumption environment, and uses the retrieved set(s) to provide an appropriate user experience to the consumer.

### BACKGROUND

Clients typically interact with machine-consumable resources using a wide variety of client platforms associated with different native computing environments. To facilitate this operation, a client may interact with a resource using a proxy mechanism. The proxy mechanism serves as an interface which maps between the native computing environment of a client and a consumable resource. For instance, a client that is operating using an object-oriented programming language (e.g., C#) may generate a proxy class for use in interacting with an XML-based web service. Another client may rely on an object-relational mapper (ORM) to interact with an SQL database.

A proxy mechanism is not fully satisfactory in all cases. For instance, a proxy mechanism provides a relatively rudimentary interface to a resource, and therefore may fail to fully exploit the full wealth of the resource's underlying characteristics and capabilities. A developer of a machine-consumable resource may attempt to mitigate this drawback by designing custom interfaces that allow different native computing environments to interact with the resource. This tactic, however, is inefficient. It requires the developer to update a library of interface components each time a change is made to the base resource. The developer will also need to develop a new interface component upon each new development in the computing arts.

### SUMMARY

A technique is described herein for facilitating a client's interaction with a machine-consumable resource, such as, but not limited to, a database, a service (including a microservice), user interface-related information (that is used to provide a consumer-side user interface presentation), etc. Broadly stated, in a definition phase, the technique creates and preserves supplemental metadata that describes the features of a resource, e.g., as those features were originally designed by developers. In a consumption phase, the technique leverages the supplemental metadata to help interpret the features in different consumption environments.

More specifically, in the definition phase, the technique can produce different sets of attributes. Each set of attributes complements a particular target consumption environment. In the consumption phase, the technique determines the characteristics of the consumption environment that a consumer is currently using. The technique then retrieves an appropriate set (or sets) of attributes associated with that consumption environment, and uses the retrieved set(s) to provide an appropriate user experience to the consumer.

A client benefits from the technique by extracting rich information regarding the characteristics and capabilities of a resource. Some of this information would otherwise have been lost in the process used to publish the resource; other information might have been otherwise hidden from the consuming client. Moreover, the client receives information that is particularly tailored to its native consumption environment. The client can provide a robust user experience by leveraging the extracted information.

A developer benefits from the technique because it reduces the amount of work that he or she is expected to perform. That is, the technique eliminates the need for a developer to create a suite of platform-specific interface components. In operation, the developer produces a single version of a resource. The technique then automatically produces separate instances of supplemental data that different clients can leverage in different consumption environments.

The above-summarized technique can be manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative computing environment for facilitating interaction with a machine-consumable resource. The environment includes a definition subsystem and a consumption subsystem.

FIG. 2 shows one implementation of the computing environment of FIG. 1.

FIG. 3 shows a code-generating component that can leverage supplemental metadata produced by the definition subsystem of FIG. 1.

FIG. 4 shows a UI-generating component that can leverage supplemental metadata produced by the definition subsystem of FIG. 1.

FIG. 5 shows a process that describes one manner of operation of the definition subsystem of FIG. 1.

FIG. 6 shows a process that describes one manner of operation of the consumption subsystem of FIG. 1.

FIG. 7 shows an illustrative type of computing device that can be used to implement any aspect of the features shown in the foregoing drawings.

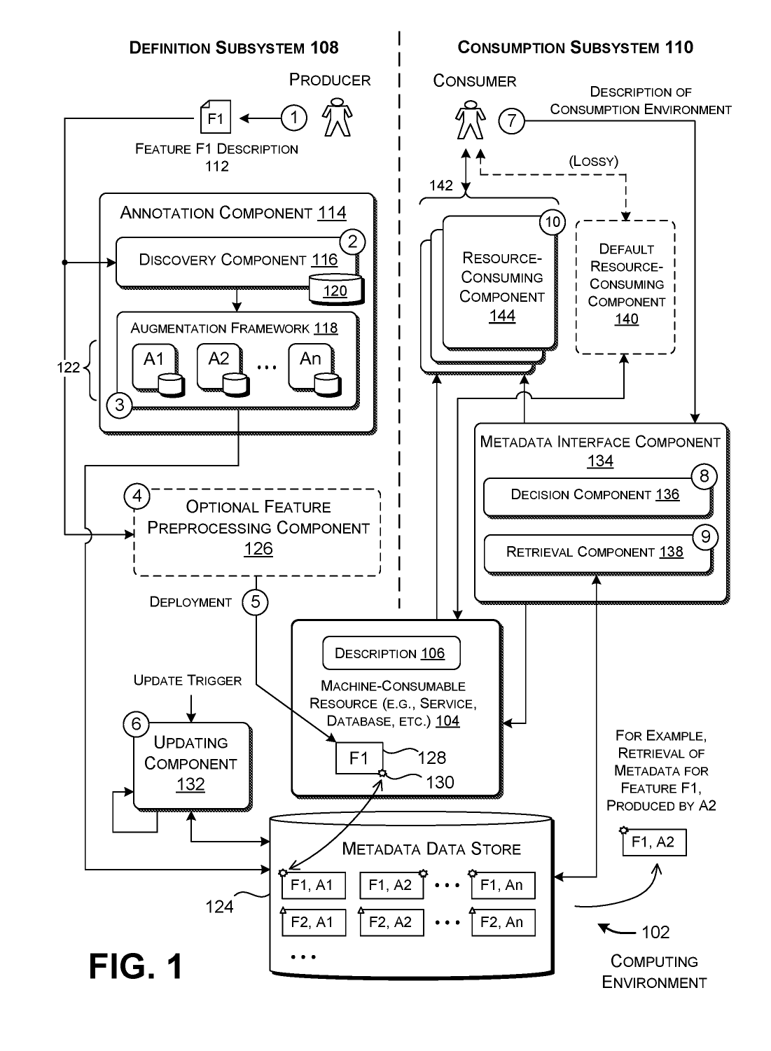

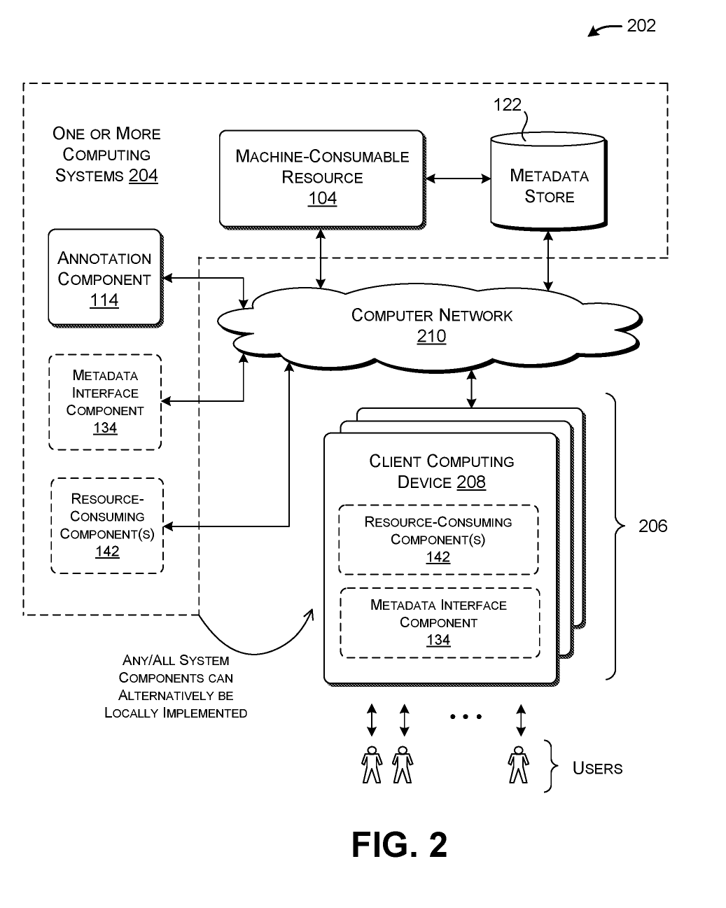

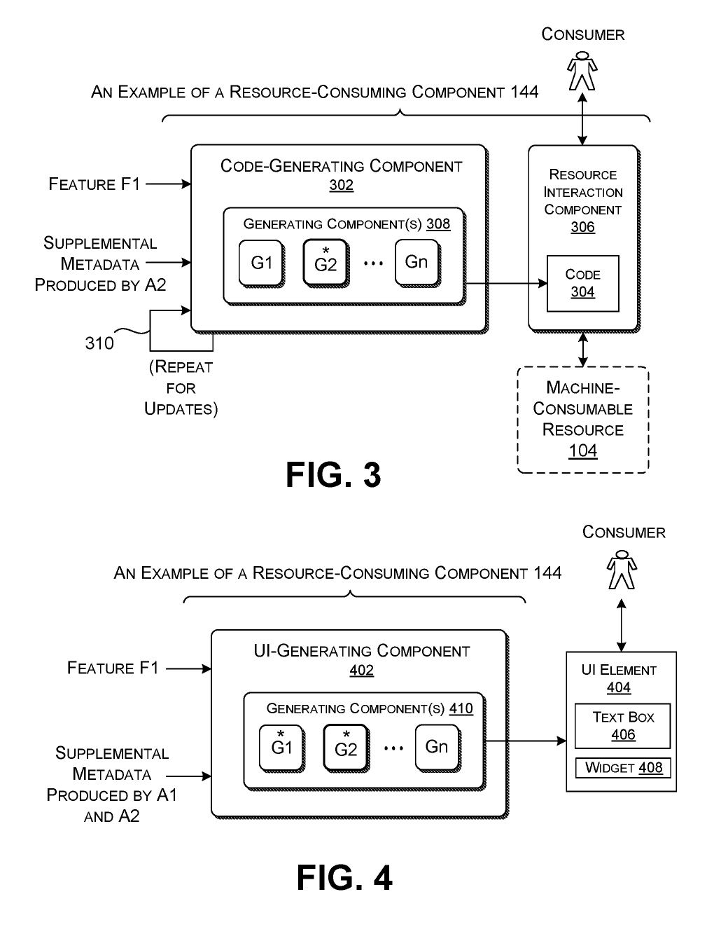

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes a computing environment for facilitating a consumer's interaction with a machine-consumable resource. Section B sets forth illustrative methods which explain the operation of the computing environment of Section A. And Section C describes illustrative computing functionality that can be used to implement any aspect of the features described in Sections A and B.

As a preliminary matter, the term “hardware logic circuitry” corresponds to one or more hardware processors (e.g., CPUs, GPUs, etc.) that execute machine-readable instructions stored in a memory, and/or one or more other hardware logic components (e.g., FPGAs) that perform operations using a task-specific collection of fixed and/or programmable logic gates. Section C provides additional information regarding one implementation of the hardware logic circuitry.

The terms “component,” “unit,” “element,” etc. refer to a part of the hardware logic circuitry that performs a particular function. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). In one implementation, the blocks shown in the flowcharts that pertain to processing-related functions can be implemented by the hardware logic circuitry described in Section C, which, in turn, can be implemented by one or more hardware processors and/or other logic components that include a task-specific collection of logic gates.

As to terminology, the phrase “configured to” encompasses various physical and tangible mechanisms for performing an identified operation. The mechanisms can be configured to perform an operation using the hardware logic circuity of Section C. The term “logic” likewise encompasses various physical and tangible mechanisms for performing a task. For instance, each processing-related operation illustrated in the flowcharts corresponds to a logic component for performing that operation. A logic component can perform its operation using the hardware logic circuitry of Section C. When implemented by computing equipment, a logic component represents an electrical component that is a physical part of the computing system, in whatever manner implemented.

Any of the storage resources described herein, or any combination of the storage resources, may be regarded as a computer-readable medium. In many cases, a computer-readable medium represents some form of physical and tangible entity. The term computer-readable medium also encompasses propagated signals, e.g., transmitted or received via a physical conduit and/or air or other wireless medium, etc. However, the specific term “computer-readable storage medium” expressly excludes propagated signals per se, while including all other forms of computer-readable media.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Finally, the terms “exemplary” or “illustrative” refer to one implementation among potentially many implementations.

A. Illustrative Computing Environment

FIG. 1 shows a computing environment 102 for facilitating a consumer's interaction with a machine-readable resource (henceforth, “resource”) 104. The resource 104 may correspond to a database (such as a database management system, etc.), a service (such as a web service, a microservice, an automated agent-provided service, etc.), user interface-related information (“UI-related information”) that is used to build a client-side user interface presentation, etc. In the case of a database, the resource 104 may include one or more tables or other data structures that store information. In the case of a service, the resource 104 may encompass a set of operations that the service may perform, or skills that the service possesses. In the case of UI-related information, the resource 104 may provide information that describes one or more user interface elements that will compose a consumer-side user interface presentation. The above-identified list of resources is presented in the spirit of illustration, not limitation; other implementations can apply the techniques described herein to other types of resources.

More specifically, as will be clarified in the examples below, in many cases, a consumer makes use of the resource 104 through a combination of logic and/or information provided by the resource 104 itself and consumer-side logic and/or information. For instance, a consumer may make use of a database through information provided by the resource 104 itself in combination with consumer-side code that the consumer uses to interact with the database.

The resource 104 uses a prescribed data model to represent its elements, such as structural typing. The resource 104 may also expose a description 106 of its contents and capabilities. For example, a web service may expose its capabilities via a Web Services Description Language (WSDL). A database may expose some information regarding its structure and content via a catalog. In the traditional case, however, a description may expose relatively raw information about an underling resource. A traditional proxy mechanism may make intelligent inferences about the characteristics and capabilities of the resource using ad hoc language-specific rules. But even with such strategies, a traditional proxy mechanism may fail to fully exploit the full wealth of the resource's underlying characteristics and capabilities. The techniques described herein ameliorate the deficiencies of this kind of traditional approach.

Overall, the computing environment 102 includes a definition subsystem 108 (generally corresponding to the elements that appear on the left side of the drawing) and a consumption subsystem 110 (generally corresponding to the elements that appear on the right side of the drawing). The definition subsystem 108 generates supplemental metadata pertaining to identified features of the resource 104. The consumption subsystem 110 provides a user experience to the consumer based on the resource 104 together with the supplemental metadata. That is, the consumption subsystem 110 leverages the supplemental metadata to help interpret the features of the resource 104.

A feature can correspond to any aspect of the resource 104, such as an entity, an operation, a skill, a description of a user interface element, etc. In other cases, a feature may correspond to a high-level feature that includes two or more component lower-level features of the same type(s) and/or different types(s). Note that FIG. 1 will be described in the illustrative context of the processing of a single feature F1, such as an individual entity or operation.

To initiate the process, the producer provides a description 112 of the feature F1 to the definition subsystem 108. The description 112 can assume different forms in different implementations. In one case, the description 112 corresponds to a portion of code that programmatically defines the feature F1 using a particular source language (such as C#). For example, the code can define a method associated with an operation. That code can specify the names of its type(s), method(s), property(ies), field(s), etc. in the source language. The code can also optionally include one or more comments. The code can optionally specify validation logic for use in determining whether an end user's input satisfies specified criteria, and so on. The code can also optionally specify security-related provisions (such as the use of encryption). In other cases, the description 112 does not correspond to executable code. For example, the UI-related information may provide the names of a user interface element's fields and the organization of those fields.

More generally, the description 112 can be said to express its information with reference to a source schema. A source schema may correspond to a formal or informal reference source which specifies the names of elements associated with a source environment in which the description F1 is defined, the arrangement of the elements, and so on.

In some cases, the producer provides the description 112 to the definition subsystem 108 as part of a process of publishing the feature F1 and installing it in the resource 104. For example, the producer may correspond to a developer who wishes to add a new operation to a web service, or a new skill to an automated agent. Here, the producer will submit the description 112 that specifies that feature to the definition subsystem 108. The definition system 108 then performs its definition process (described below) together with a publication process. Assume that this scenario applies to the example of FIG. 1. In other cases, the producer may wish to apply the definition process for a feature that is already installed in the resource 104, that is, without also performing the publication process.

An annotation component 114 adds supplemental metadata to the description 112. The supplemental metadata, in turn, can include one or more attributes. The term “supplemental metadata” is used to distinguish it from any “original metadata” that may be present in the description 112 as originally defined by the producer. The supplemental metadata assists the consumption subsystem 110 in interpreting the feature F1.

The annotation component 114 performs its work in two phases using two respective components: a discovery component 116 and an augmentation framework 118. The discovery component 116 explores the description 116 to identify its characteristics. For instance, for a code snippet, the discovery component 116 can identify the names that the description 112 assigns to its type(s), method(s), property(ies), field(s), etc. The discovery component 116 can also identify any operations specified in the description 112, and the order in which those operations appear. The discovery component 112 can also identify any comments and original metadata that appear in the description 112. The discovery component 112 can also identify any validation logic that appears in the description, and so on.

Generally, the discovery component 116 performs its operations by processing the description 112 using a set of analysis and extraction rules. One such illustrative kind of rule can be expressed in an IF-THEN format. That kind of rule determines whether the description 112 conforms to a pattern X; if so, the discovery component 116 extracts information Y from the description 112 (or otherwise draws a conclusion Z about the description 112). For example, such a rule can identify a language-specific telltale pattern in which a developer creates a class in a particular language. In response, the discovery component 116 can extract the name associated with the class itself, and the names associated with its property(ies), field(s), etc. The discovery component 116 stores whatever characteristics it finds in a data store 120.

The discovery component 116 can rely on known technology to perform this operation. For instance, the discovery component 116 can use the programmatic technique referred to as reflection to identify the principal elements of the description 112 (that is, if reflection is supported by the underlying language in which the description 112 is expressed). Alternatively, the discovery component 116 can perform its task using a lexer and parser. A lexer performs lexical analysis on the description 112 by decomposing it into its component tokens (strings). A parser performs syntactic analysis on the description 112 to identify its meaning. Both the lexer and the parser perform their respective tasks with reference to a stored set of analysis rules.

The augmentation framework 118 maps the characteristics discovered by the discovery component 116 to supplemental metadata. More specifically, the augmentation framework 118 can include a set of augmentation components 122 (A1, A2, A3, . . . , An). Each augmentation component identifies its own subset of supplemental metadata for use in an identified target consumption environment. That is, each subset of supplemental metadata, which includes a set of attributes, is specifically tailored to assist a client computing device (and/or the consumer himself/herself) in interpreting and utilizing the feature F1 in a particular target consumption environment. The term target “consumption environment” refers to a context in which the feature F1 will be consumed by a consumer in the consumption subsystem 110.

The target consumption environment associated with an augmentation component can be defined with respect to one or more dimensions, and in any level of generality. For example, an augmentation component may be directed to a particular programming language that a client computing device will use to consume the feature F1, such as C#, JAVASCRIPT, or TYPESCRIPT, etc. Alternatively, an augmentation component may be directed to a general class of programming languages, such as static typing programming languages, dynamic typing programming languages, functional programming languages, etc.

Alternatively, or in addition, an augmentation component may be directed to a particular kind of user interface presentation. For example, an augmentation component may be directed to a kind of user interface presentation that provides input validation, or a kind of user interface presentation that provides help information, etc.

Alternatively, or in addition, an augmentation component may be directed to consumers who have one or more specified characteristics. For example, an augmentation component may be directed to users who speak an identified natural language (e.g., French), and/or users who share an identified skill level, and/or users who have otherwise expressed particular preferences, etc.

More generally, the target consumption environment can be said to express its information with reference to a consumption schema. A consumption schema may correspond to a formal or informal reference source which specifies the names of elements associated with a consumption environment, the arrangement of the elements, and so on.

In some cases, an augmentation component is source-agnostic. Such an augmentation component generates a subset of metadata for a target consumption environment regardless of the manner of expression that is used to express the description 112, as represented by the source schema. For example, such an augmentation component may be tailored to a consumption environment that uses the JAVASCRIPT language, regardless of the programming language used to express the description 112. In other cases, an augmentation component may limit its application to a specific source-to-target pairing. For example, such an augmentation component may be tailored to the case in which the description 112 is in the C# programing language and the consuming environment uses the JAVASCRIPT language.

In one implementation, each augmentation component performs its operation by making reference to a set of mapping rules. One such kind of rule can be phrased in an IF-THEN format. Such a rule determines whether the identified characteristics of the description 112 include information K (or pattern K); if so, then the augmentation component annotates the description with an attribute L. In some cases, a rule transforms information that appears in the description in an original form to a target synonymous form. For instance, an illustrative rule can determine whether the description 112 includes an operation name “Project”; if so, the augmentation component adds an attribute that identifies the alternative name “project,” or “map,” or “SELECT,” etc. In other cases, a rule seeks to preserve information that appears in the original description 112 without transforming it. For example, one such rule can determine whether the description 112 includes a comment; if so, the augmentation component stores an attribute that corresponds to the comment. A rule that performs a preservation role allows the definition subsystem 108 to retain information that may be stripped off or otherwise “flattened” in the course of the publication process, e.g., in the course of converting programmatically-expressed entity classes into entries of a database that uses a particular data model (e.g., a structural typing data model).

Alternatively, or in addition, an augmentation component may generate a subset of metadata using a machine-trained model. For example, an augmentation component can use a convolutional neural network (CNN) that maps the text of the description 112 (and/or its characteristics identified by the discovery component 116 and stored in the data store 120) to a subset of metadata.

In other cases, an augmentation component can add one or more attributes that control the interpretation of parameters. For example, an augmentation provider can add an attribute which indicates that a collection of parameters is to be interpreted as a tuple.

The augmentation component can tag the set of attributes that it produces with a unique identifier to describe its origin. For instance, an augmentation component can add an identifier that indicates that a set of attributes pertains to a particular feature, or, in some cases, to a particular aspect of a feature. In an addition, the identifier can reveal that the set of attributes has been generated by a particular augmentation provider. The identifier therefore indirectly specifies the target consumption environment to which the set of attributes is directed. In the above example, the identifier may correspond to a code that is associated with a set of attributes. In other cases, the identifier may correspond to a field or location at which a set of supplemental metadata is stored; here, the computing environment 102 associates an identifier with a set of supplemental metadata by storing the set at a particular location.

The annotation component 114 may store the supplemental metadata in a metadata data store 124. As shown in the depiction of FIG. 1, the supplemental metadata includes separate sets of attributes generated by different augmentation components. For instance, consider the set of attributes bearing the label “F1, A1.” This label indicates the set of attributes pertains to a feature F1, and that the set originated from a particular augmentation component (having the identifier A1).

In one case, the metadata data store 124 corresponds to a store that is separate from the resource 104. In another case, the metadata data store 124 and the resource 104 are integrated together. For instance, in the latter case, the metadata data store 124 may correspond to field for storing supplemental information within the resource 104 itself.

An optional feature preprocessing component 126 performs processing on the feature F1 prior to installing it in the resource 104. For example, the feature preprocessing component 126 may anonymize user-specific names in the feature prior to publishing it. Any information that is removed in this process will not necessarily be lost however, as the annotation component 114 may have captured and preserved this information prior to its removal. In addition, the feature preprocessing component 126 can serialize the feature F1 for transmission to whatever computing system implements the resource 104.

FIG. 1 shows a representation of the feature F1 128 after it is installed in the resource 104. The feature F1 128 may include an identifier 130 which links the feature to its instance of supplemental metadata that is stored in the metadata data store 124. Its instance of supplemental metadata, in turn, can include one or more sets of attributes provided by different augmentation components. In another example, the feature F1 128 is stored together with its supplemental metadata.

In another example (not shown), a single feature can include plural identifiers, each of which maps to one or more sets of attributes. For example, a feature may correspond to an operation. The operation can encompass different aspects, each of which maps to one or more sets of attributes. To simplify the explanation, however, the description will henceforth describe the case in which each feature is represented by a single identifier which maps to one or more sets of attributes.

An updating component 132 can provide additional supplemental metadata at any time(s) following the above-described processing operations. Different events may trigger an update operation. For example, a developer may manually invoke the update operation when a new target consumption environment is identified (e.g., when a new programming language is identified) or an existing target consumption environment is modified. In that case, the updating component 132 can provide a new (or modified) set of attributes that pertains to the new (or modified) target consumption environment. The updating component 132 can provide the new (or modified) set of attributes using a new (or modified) augmentation component. In other cases, the updating component 132 periodically performs the update operation without being explicitly commanded to do so by a developer. In this case, the updating component 132 can take account for any changes to the computing environment 102 (and any changes to the target consumption environments) since the last definition process was performed, including both incremental changes and the introduction of one or more entirely new target consumption environments (associated with one or more corresponding augmentation components).

The updating component 132 can perform its analysis based on various sources of information. For example, the updating component 132 can operate on existing metadata in the metadata data store 124. For instance, the updating component 132 can expand a name that already appears in the supplemental metadata to a set of names. More specifically, for example, the updating component 132 can determine that the existing name is a parent node in an ontology of names; it will then produce additional names that correspond to children of that parent node. Alternatively, or in addition, the updating component 132 can operate on the characteristics stored by the discovery component 116 in the data store 120.

The updating component 132 can store any new supplemental metadata that it generates in the metadata data store 124. In some cases, the new supplemental metadata represents an expansion of an existing set of attributes. In other cases, the new supplemental metadata corresponds to a new set of attributes that is assigned its own unique identifier.

Note that the above explanation described the annotation component 114 and the updating component 132 as producer-side processes. But a consumer can also contribute to these processes. For example, a consumer can invoke an update operation (performed by the updating component 132) to generate supplemental metadata that facilitates translation of information into a specified natural language, or that fixes camel casing for a particular programming language, etc. In this context, the consumer may also provide whatever information sources may be need to generate the supplemental metadata.

Now referring to the consumption subsystem 110, a consumer may begin the consumption process by submitting a message (in one or more parts) that identifies the feature or features with which he or she wishes to interact. For example, the consumer may specify that he or she wishes to retrieve information regarding a particular entity in a database. Or the consumer may specify that he or she wishes to invoke a particular operation performed by a web service. Or the consumer may specify that he or she wishes to display a particular user interface element. In the scenario of FIG. 1, assume that the consumer wishes to interact with the feature F1.

In the same message, or in a separate message, the consumer identifies the target consumption environment. More specifically, the consumer may manually supply this information. Alternatively, or in addition, a client computing device with which the consumer is interacting may submit the information on behalf of the consumer, e.g., by automatically detecting characteristics of the target consumption environment and then forwarding a message that identifies those characteristics.

For example, the consumer may submit information that identifies the programming language that a client computing device uses to interact with the resource 104. This information can be specified in any level of granularity, e.g., by identifying the specific language (e.g., C#) that is being used or by identifying the type of language that is being used. Alternatively, or in addition, the consumer may submit information that identifies the physical characteristics of the client computing device that he or she is using. That information has a bearing on the manner in which the consumer is able to interact with the resource 104. Alternatively, or in addition, the consumer can identify his or her own characteristics, such as his or her native language, his or her skill level, etc. Alternatively, or in addition, the consumer may submit information which describes the context in which interaction with the resource 104 will take place, such as the geographical location of the consumer, the current time, etc.

Alternatively, or in addition, the consumer may submit information which describes the desired or mandated security constraints associated with the target consumption environment. These security constraints may govern the consumption environment's encryption requirements, auditing requirements, protocols with respect to the handling of personal identifiable information, protocols with respect to the retention and destruction of information in general, etc.

A metadata interface component 134 receives the information submitted by the consumer. In response, it retrieves appropriate supplemental metadata from the metadata data store 124. In some cases, the metadata interface component 134 refers to a component that operates at a remote location relative to the client computing device that submits the information. In other cases, the metadata interface component 134 refers to a component that is provided by the client computing device, or by some other device that is local with respect to the client computing device. In other cases, the metadata interface component 134 refers to logic that is distributed among two or more devices.

In one implementation, the metadata interface component 134 includes a decision component 136 which identifies one or more sets of attributes that are appropriate for the specified consumption environment. The decision component 136 can perform this task using different technology. For example, the decision component 136 can consult a lookup table that maps the identified characteristics of the consumption environment to a choice of attribute set(s). A retrieval component 138 then selectively retrieves the identified set(s) of attributes from the metadata data store 124.

In some cases, the decision component 136 matches the consumption environment to attribute set(s) using fuzzy matching logic, e.g., by selecting the set(s) that are most appropriate, even if not perfect matches. The decision component 136 can perform this matching operation using various technology. For instance, the decision component 136 can perform its matching by applying a hierarchical series of rules. For example, assume that the target consumption environment involves the use of a specific programming language XYZ, corresponding to language category T. The decision component 136 can first determine if there is an attribute set which is specifically associated with the programming language XYZ. If so, the decision component 136 will select that set. If not, the decision component 136 can determine whether there is an attribute set which is associated with the language category T. In another example, the decision component 136 can: (1) use a deep neural network (DNN) to map the characteristics of the target consumption environment into a first vector; (2) map information regarding a candidate attribute set using the DNN into a second vector; and (3) then use a cosine similarity measure to determine the distance between the first and second vectors.

In some cases, the decision component 136 performs its search by performing a disjunctive matching operation. For example, assume that the target consumption environment is characterized by the use of the programming language XYZ by a consumer who speaks French. The decision component 136 can find a first set of attributes that is appropriate to the programming language XYZ, and a second set of attributes that is appropriate to the French language. The consumer can leverage both sets of attributes in interacting with the resource 104. As a more general point, note that the sets of attributes may complement each other in some cases; in other words, they are not necessarily mutually exclusive in all instances

In the example of FIG. 1, assume that the decision component 136 determines that the set of attributes produced by the second augmentation component (A2) is appropriate for the current consumption environment. The retrieval component 138 can then selectively retrieve the set of attributes labeled (F1, A2) from the metadata data store 124. In other cases, the decision component 136 determines that plural subsets of attributes are appropriate, upon which the retrieval component 138 retrieves those sets.

In another implementation, the retrieval component 138 can initiate the extraction processing by extracting all of the supplemental metadata associated with the identified feature F1. The decision component 136 then selects a custom set of attributes from among the entire body of metadata. The decision component 136 can perform this task using the same technology described above, e.g., by consulting a lookup table.

In other cases, the metadata interface component 134 will return a result that indicates that no supplemental metadata is relevant to the current consumption environment. In that situation, the consumer may rely on a default resource-consuming component 140 to interact with the resource 104. For example, the default resource-consuming component 140 can correspond to a conventional proxy generator for producing a proxy class by which the consumer may interact with a web service. Or the default resource-consuming component 140 may correspond to an object-relational mapper (ORM) by which the consumer may interact with a database, etc.

FIG. 1 indicates that the default resource-consuming component 140 may provide a lossy interface with the resource 104. For instance, the default resource-consuming component 140 may generate a proxy mechanism based on information exposed by the resource's description 106. But the description 106 may not represent the full wealth of detail regarding the underlying characteristics and capabilities of the resource's features, as originally created by the developer(s). This lack of information may be due to the removal of certain details regarding the resource 104 in the course of the publication process, and/or the failure of the description 106 to provide robust information that is relevant to the current consumption environment. The interface is considered lossy because the information exposed to the consumer is a degraded subset of the information originally defined by the producer(s).

A group of other resource-consuming components 142 rely on supplemental metadata provided by the metadata interface component 134. For example, a representative resource-consuming component 144 may generate code based, in part, on the supplemental metadata. That resource-consuming component 144 may subsequently use that code in interacting with a database or service. Or the resource-consuming component 144 may generate a user interface presentation based, in part, on the supplemental metadata. The operation of the resource-consuming component 144 will be described in greater detail below with reference to FIGS. 3 and 4.

FIG. 1 is annotated with reference numbers to summarize the sequence of operations described above. In summary, in operation (1) of the definition process, the producer submits a description 112 of feature F1. In operation (2), the discovery component 116 identifies the characteristics of the description 112 and stores those characteristics in the data store 120. In operation (3), the augmentation framework 118 produces supplemental metadata based on the identified characteristics and stores that metadata in the metadata data store 124. In operation (4), the optional preprocessing component 126 performs processing on the feature F1 in preparation for publishing it. In operation (5), the feature prepossessing component 126 installs the feature F1 in the resource 104 (if not already installed). Operation (6) indicates that the updating component 132 can add new supplemental metadata at any time(s) following operations (1)-(5).

In the consumption process, in operation (7), the consumer can submit a request to interact with the feature F1. The consumer also identifies the characteristics of the current consumption environment. In operations (8) and (9), the decision component 136 and the retrieval component 138 identify and retrieve appropriate supplemental metadata that complements the identified consumption environment. In some cases, operation (8) precedes operation (9); in other cases, operation (9) precedes operation (8). (More generally, the order of the operations described in this summary is illustrative and non-limiting; other implementations can vary the order of these operations in various ways.) In operation (10), the resource-consuming component 144 leverages the retrieved supplemental metadata to provide an appropriate user experience to the consumer.

Overall, the computing environment 102 confers various benefits. First, the computing environment 102 exposes a rich set of metadata to the consumer that is specifically tailored to the consumer's current consumption environment. By doing so, the computing environment 102 effectively apprises the consumer of the capabilities and limitations of the resource 104 in a current context. The consumer may also leverage the supplemental metadata to more effectively interact with the resource 104, e.g., by accessing specific entities and operations exposed by the supplemental metadata.

In other words, the resource-consuming component 144 (which leverages the supplemental metadata) may provide an interface that is less lossy compared to the default resource-consuming component 140 (which does not leverage the supplemental metadata). The default resource-consuming component 140 is particularly deficient because it relies on relatively raw information exposed by the resource 104 via its description 106. Further note that the resource 104 exposes the same description 106 to the default resource-consuming component 140 for all consumption environments.

The computing environment 102 also fosters an efficient development process. The developer is tasked with the responsibility of developing a single version of the resource 104. The definition subsystem 108 then enumerates supplemental metadata pertaining to different target consumption environments in which the resource 104 may be used. The developer need not perform the painstaking task of creating separate versions of the resource 104 for different consumption environments or different interface components which provide access to the resource 104 for different consumption environments.

FIG. 2 shows computing equipment 202 that represents one implementation of the computing environment 102 of FIG. 1. The computing equipment 202 includes one or more computing systems 204. Each computing system may correspond to one or more servers. The computing equipment 202 also includes a plurality of client computing devices 206 (including representative client computing device 208) for interacting with the computing system(s) 204 via a computer network 210. Each client computing device can correspond to any of a server, a workstation-type personal computing device, a laptop-type computing device, a tablet-type computing device, a smartphone, a game console, a virtual reality device, a wearable computing device, and so on (or any combination thereof). The computer network 210 may correspond to a local area network, a wide area network (e.g., the Internet), one or more point-to-point communications links, and so on (or any combination thereof). The computer network 210 may be governed by any protocol or combination of protocols.

In one implementation, the computer system(s) 204 implement the resource 104, the metadata data store 124, the annotation component 114, at least part of the metadata interface component 134, and at least some of the resource-consuming components 142. Each client computing device can implement at least part of the metadata interface component 134 and at least some of the resource-consuming components 142. However, other implementations can vary the allocations shown in FIG. 2 in any manner. For example, in another implementation, all of the components are implemented in local fashion by each client computing device, including the resource 104 and the metadata data store 124.

FIG. 3 shows one example of the resource-consuming component 144 introduced in FIG. 1. In this example, a code-generating component 302 generates code 304. A resource interaction component 306 then utilizes the code to interact with the resource 104. The resource 104 in this example may correspond, for instance, to a database or a service.

The code-generating component 302 receives input that identifies the aspect of the resource 104 with which the consumer wishes to interact. In this case, assume that the consumer wishes to interact with the feature F1, which may correspond to an entity associated with a table or an operation provided by a service. The code-generating component 302 also receives a set (or sets) of attributes pertaining to the current consumption environment. In this case, assume that the code-generating component 302 receives a set of attributes generated by the augmentation component A2. For instance, that set of attributes may be appropriate for a programming language being used by a client computing device in the current consumption environment.

In one implementation, the code-generating component 302 maps the elements specified by the feature F1 and the supplemental metadata to code in a particular computing language. In doing so, the code-generating component 302 creates appropriate type names, method names, field names (and associated appropriate attributes), property names, etc. For example, assume that the supplemental metadata reveals that the description 112 includes elements of type “Person” with properties “Name” and “Age.” The code-generating component 302 can process this information by generating a Person class including the properties of Name and Age. The code-generating component 302 also returns the type name (Person) any time that type is referenced throughout the code. The code-generating component 302 can perform its code-generating operation using a set of stored transformation rules. Each transformation rule can be expressed in an IF-THEN format or any other logical format. That is, an illustrative rule can determine whether an element R is present in the feature and/or the supplemental metadata; if so, the code-generating component 302 adds a corresponding programmatic element R′ to the code.

More specifically, in one implementation, the code-generating component 302 provides a suite of generating components 308 to generate code for specific use cases. For example, the generating component G1 generates code for supplemental metadata generated by the augmentation component A1, the generating component G2 generates code for the supplemental metadata generated by the augmentation A2, and so on. FIG. 3 shows the case in which the code-generating component 302 exclusively invokes the generating component G2. But as mentioned above, the sets of attributes are not mutually exclusive. Hence, in other cases, the code-generating component 302 can invoke two or more code-generating components.

In some implementations, the code-generating component 302 generates the code 304 using a two-step procedure. In a first phase, the code-generating component 302 generates an intermediate file. The intermediate file provides a compilation of all of the metadata that is necessary to generate the code 304, extracted from the feature F1 and the supplemental metadata. In a second phase, the code-generating component 302 produces the code based on the intermediate file. One non-limiting and environment-specific example of a format for expressing an intermediate file is the database markup language (DBML) format. An ORM can convert information from an SQL database into a DBML file; a code generator can then use the DBML file to produce code associated with a particular language (such as C#).

A loop 310 represents the fact that the code-generating component 302 can update the code 304 that it generates at any time(s). By doing so, the code-generating component 302 can take into account new supplemental metadata that has been received since its last code-generating operation. In some cases, a consumer may initiate the updating operation represented by the loop 310. For instance, an alert component (not shown) may notify the user when it detects that new supplemental metadata has been added to the data store 124 that is pertinent to previously-generated code 304 (and the target consumption environment associated with that code 304). The consumer may then manually invoke the updating operation. Or the code-generating component 302 can automatically perform the updating operation associated with the loop 310 without being prompted to do so by the consumer.

Consider the scenario in which the resource-consuming component 144 is used to retrieve information from a remote source. In one implementation, the code-generating component 302 produces code 304 for use in extracting discrete pieces of information from a database (such as an SQL database), e.g., by issuing discrete requests to the database. In another implementation, the code-generating component 302 produces code 304 for interacting with at least one sequence of information produced by a remote source in an asynchronous and event-driven manner, e.g., using the Reactive Extensions (Rx) library provided by MICROSOFT CORPORATION of Redmond, Washington. In that case, the resource interaction component 306 uses the code 304 to subscribe to a stream of information supplied by the resource 104 and to subsequently control its delivery.

For instance, the code-generating component 302 can generate the following class for an entity “Person” that appears in the supplemental metadata.

class Person
{

[Mapping(...)]
public int Name {get; set;}
[Mapping(...)]
public int Age {get; set;}
. . .

The code-generating component 302 can generate the following code for interacting with a stream of information associated with the Person entity, as expressed in the Reactive Extensions (Rx) programming paradigm:

class MyContext: RxServiceContext
{

public MyContext( ) : base(cxnParams){ }
public IObservable<Person>PersonObservable
{

get{return this.GetObservable<Person>(...);

}
. . .

To accommodate the needs for some consumers (such as consumers that use nominal rather than structural types), the code-generating component 302 can merge structurally equivalent types into a single nominal type. For example, in the Rx paradigm, assume that a first observable is associated with a data source that provides a stream of weather-related data for Seattle, and a second observable is associated with a stream of weather-related data for Boston. The code-generating component 302 can associate these two entities with a single nominal type, rather than two separate types. This conflation permits a consumer to merge the two streams from the two data sources or perform other joint operations on the two streams. Without this conflation operation, the code-generating component 302 might have interpreted the two data sources as two distinct types. Note that other consumers (such as TYPESCRIPT consumers) may entirely omit the above-described processing.

FIG. 4 shows another example of the resource-consuming component 144 for use in the computing environment 102 of FIG. 1. In this example, a UI-generating component 402 generates a user interface (UI) element 404. The UI element 404 includes a text box 406 for use in receiving information from an end user. The UI element 404 also includes a widget 408 beneath the text box 406. For example, the widget 408 may provide a help link for use by the end user in interacting with the UI element 404.

The UI-generating component 402 receives input that describes the feature F1. For instance, the feature F1 may describe the use of the UI element 404 for receiving information pertaining to a specified input field. The UI-generating component 402 also receives a set (or sets) of attributes pertaining to the current consumption environment. In this case, assume that the UI-generating component 402 receives two sets of attributes produced by the first augmentation provider A1 and the second augmentation provider A2, respectively.

In one implementation, the UI-generating component 402 provides a suite of generating components 410 to generate the UI element 404 for specific use cases. For example, in one merely illustrative case, the generating component G1 provides code that provides validation logic for any input that the end user inputs into the text box 406. The generating component G1 performs this task in response to an attribute in the supplemental data (provided by augmentation component Al) that indicates that it is appropriate to provide validation of the user's input. The augmentation component A1, in turn, may have added this attribute in response to evidence in the original description 112 that a developer intended to provide validation of user input.

For instance, that evidence may correspond to code in the description 112 that performs validation. Alternatively, or in addition, the evidence may take the form of one or more comments in the description 112 that pertain to validation logic. Alternatively, or in addition, the augmentation component Al may determine that the target audience associated with the consumption environment will benefit from validation logic, even if the developer himself/herself did not specify its use.

The generating component G2 supplies the widget 408 beneath the text box 406. The generating component G2 supplies the widget 408 in response to an attribute produced by the augmentation provider A2 that invokes this feature. The augmentation provider A2 adds this attribute, in turn, based on evidence in the original description 112 that indicates that the developer intended to provide this feature, and/or based on insight regarding the anticipated needs of the target audience of the consumption environment.

More generally, the UI-generating component 402 can govern any aspect of the UI element's behavior and/or appearance based on the supplemental metadata. In other cases, the UI-generating component 402 can leverage the supplemental metadata to control the following aspects: the shape of the UI element 404; the size of the UI element 404; the transparency and/or color of the UI element 404; the position of the UI element; the use of spellchecking in conjunction with the UI element 404; the use of error messages in conjunction the UI element 404; the addition of a checkbox in association with the UI element 404; the use of a date/time-picker in association with the UI element 404, and so on.

Although not shown, another type of UI-generating component can apply the same mechanisms set forth above to provide a speech-based interface. That is, that kind of UI-generating component can receive a description of a speech-based interface, along with supplemental metadata. The UI-generating component can produce a customized speech-based interface based on the description of the speech-based interface and the supplemental metadata.

More generally, FIGS. 3 and 4 provide only two of many type of resource-consuming components. For example, assume that the resource 104 corresponds to an automated agent, such as a digital personal assistant (e.g., a chatbot). In that case, the resource-consuming component 144 can control the configuration of the automated agent based on the supplemental metadata. For example, an augmentation component may detect evidence that a feature is intended for use by end users with specific characteristics, such as foreign-language speakers or children. The augmentation provider can produce at least one attribute that conveys this observation. In the consumption process, the resource-consuming component 144 can determine whether a consumer is a member of a target audience. If so, the resource-consuming component 144 can retrieve a set of attributes associated with that consumption environment, and use that set of attributes to control its interaction with the automated agent. For instance, the resource-consuming component 144 can instruct the automated agent to invoke an appropriate language understanding (LU) model, an appropriate dialog management model, etc.

In other cases, the resource-consuming component 144 performs the task of collecting the supplemental metadata without otherwise interacting with the resource 104. The resource-consuming component 144 then exposes the supplemental metadata to some other process. Or the resource-consuming component 144 can perform any data manipulation operations on the supplemental data. For example, the resource-consuming component 144 can leverage the supplemental metadata to produce a custom report.

In yet another case, a component can make changes to the resource 104 itself based on the metadata. For example, an updating component can update the description 106 (such as the WDSL description) of the resource 104 based on the supplemental metadata, e.g., so that the description encompasses the new attributes in the supplemental metadata.

B. Illustrative Processes

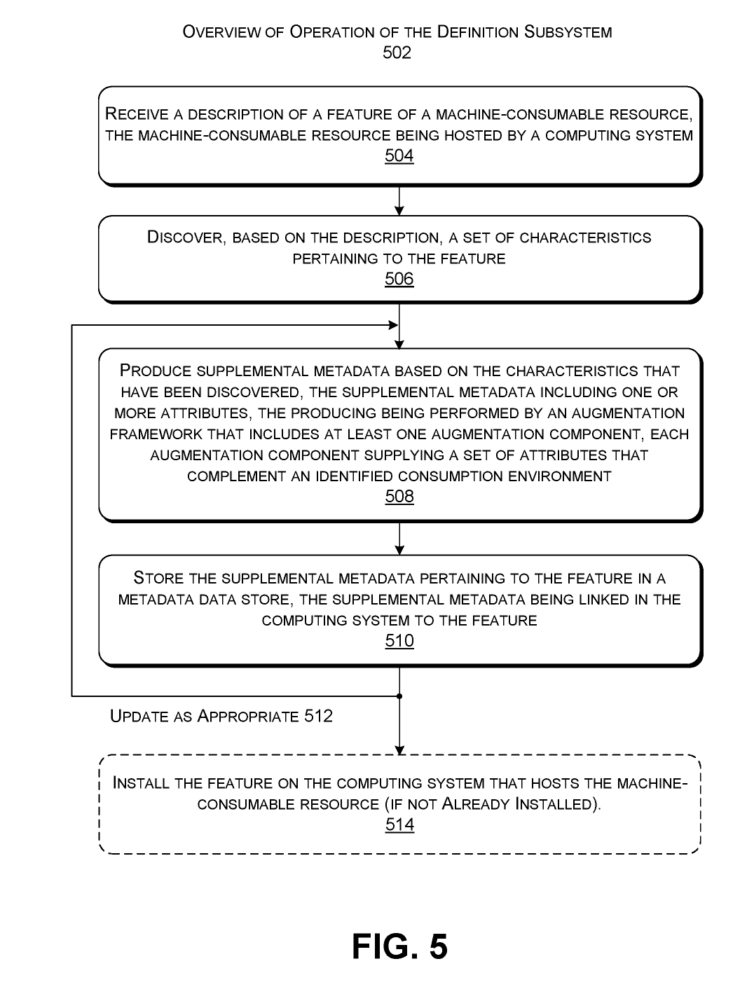

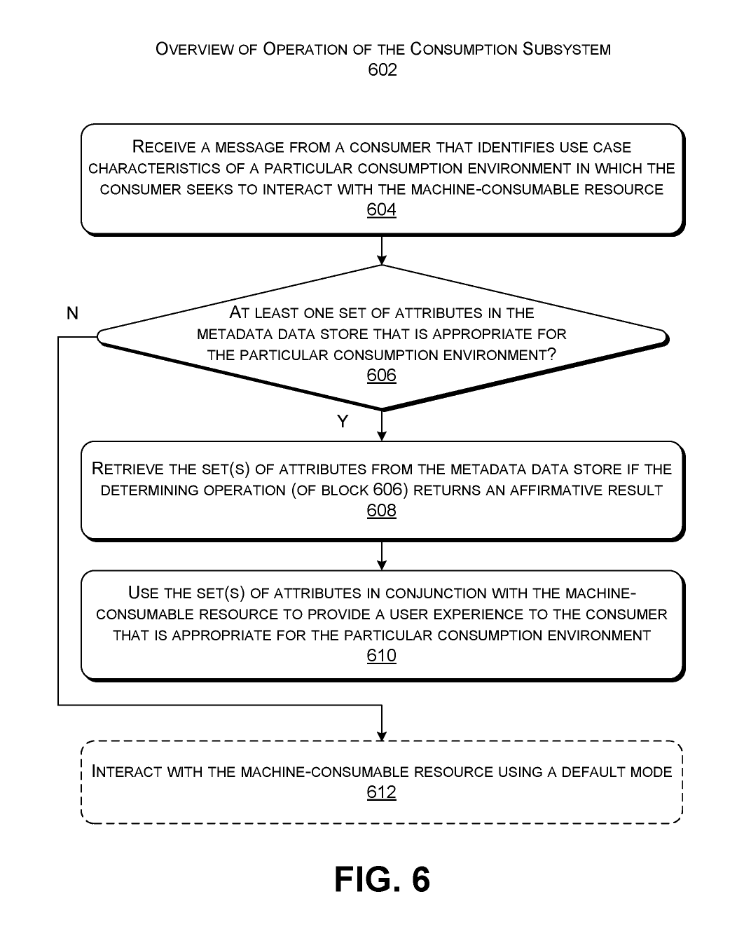

FIGS. 5 and 6 show processes that explain the operation of the computing environment 102 of Section A in flowchart form. Since the principles underlying the operation of the computing environment 102 have already been described in Section A, certain operations will be addressed in summary fashion in this section. As noted in the prefatory part of the Detailed Description, each flowchart is expressed as a series of operations performed in a particular order. But the order of these operations is merely representative, and can be varied in any manner.

FIG. 5 shows a process 502 that describes one manner of operation of the definition subsystem 108. In block 504, the definition subsystem 108 receives a description of a feature of a machine-consumable resource 104, the machine-consumable resource 104 being hosted by a computing system. In block 506, the definition subsystem 108 discovers, based on the description, a set of characteristics pertaining to the feature. In block 508, the definition subsystem 108 produces supplemental metadata based on the characteristics that have been discovered, the metadata including one or more attributes. This producing operation is performed by the augmentation framework 118 that includes at least one augmentation component, wherein each augmentation component supplies a set of attributes that complement an identified consumption environment. Further, each identified consumption environment is defined, at least in part, by a consumption schema. In block 510, the definition subsystem 108 stores the supplemental metadata pertaining to the feature in the metadata data store 124, the supplemental metadata being linked in the computing system to the feature. Each set of attributes is thereafter used to control a user experience in an associated consumption environment. Block 512 indicates that the definition subsystem 108 can repeat blocks 508 and 510 any number of times upon the occurrence of a triggering event. This will have the effect of adding new attributes to the supplemental metadata. In optional block 514, the definition subsystem 108 may install and publish the feature on the computing system that hosts the machine-consumable resource 104.

FIG. 6 shows a process 602 that describes one manner of operation of the consumption subsystem 110. In block 604, the consumption subsystem 110 receives a message from a consumer that identifies use case characteristics of a particular consumption environment in which the consumer seeks to interact with the machine-consumable resource. In block 606, the consumption subsystem 110 determines, based on the use case characteristics, whether there is at least one set of attributes in the metadata data store 124 that is appropriate for the particular consumption environment. Each set of attributes in the metadata data store 124 is produced, prior to receiving the message, by an augmentation component. Further, each set of attributes complements an identified consumption environment. In block 608, the consumption subsystem 110 retrieves the set(s) of metadata from the metadata data store 124 if the determining operation of block 606 returns an affirmative result. In block 610, the consumption environment 110 uses the set(s) of metadata to provide a user experience to the consumer that is appropriate for the particular consumption environment. In block 612, if the determining operation of block 606 returns a negative result, then the consumption subsystem 110 interacts with the machine-consumable resource 104 in a default mode (that does not rely on supplemental metadata).

C. Representative Computing Functionality

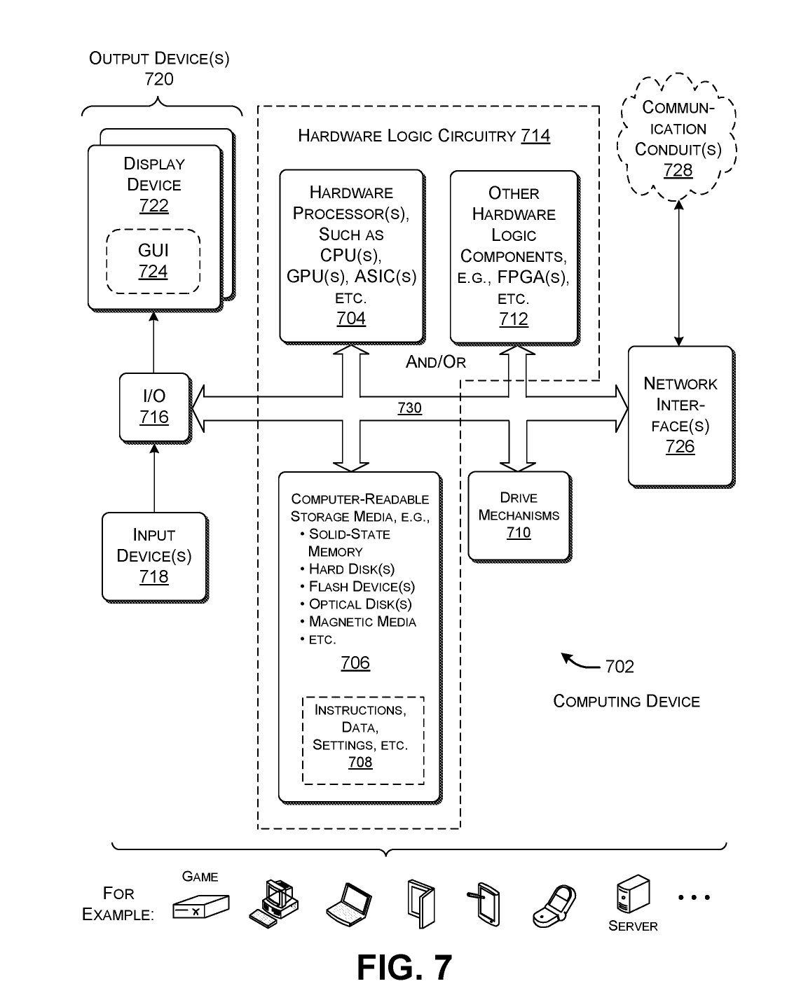

FIG. 7 shows a computing device 702 that can be used to implement any aspect of the mechanisms set forth in the above-described figures. For instance, with reference to FIG. 2, the type of computing device 702 shown in FIG. 7 can be used to implement any computing device associated with the computing system(s) 204, any and any of the client computing devices 206, etc. In all cases, the computing device 702 represents a physical and tangible processing mechanism.

The computing device 702 can include one or more hardware processors 704. The hardware processor(s) can include, without limitation, one or more Central Processing Units (CPUs), and/or one or more Graphics Processing Units (GPUs), and/or one or more Application Specific Integrated Circuits (ASICs), etc. More generally, any hardware processor can correspond to a general-purpose processing unit or an application-specific processor unit.

The computing device 702 can also include computer-readable storage media 706, corresponding to one or more computer-readable media hardware units. The computer-readable storage media 706 retains any kind of information 708, such as machine-readable instructions, settings, data, etc. Without limitation, for instance, the computer-readable storage media 706 may include one or more solid-state devices, one or more magnetic hard disks, one or more optical disks, magnetic tape, and so on. Any instance of the computer-readable storage media 706 can use any technology for storing and retrieving information. Further, any instance of the computer-readable storage media 706 may represent a fixed or removable component of the computing device 702. Further, any instance of the computer-readable storage media 706 may provide volatile or non-volatile retention of information.

The computing device 702 can utilize any instance of the computer-readable storage media 706 in different ways. For example, any instance of the computer-readable storage media 706 may represent a hardware memory unit (such as Random Access Memory (RAM)) for storing transient information during execution of a program by the computing device 702, and/or a hardware storage unit (such as a hard disk) for retaining/archiving information on a more permanent basis. In the latter case, the computing device 702 also includes one or more drive mechanisms 710 (such as a hard drive mechanism) for storing and retrieving information from an instance of the computer-readable storage media 706.

The computing device 702 may perform any of the functions described above when the hardware processor(s) 704 carry out computer-readable instructions stored in any instance of the computer-readable storage media 706. For instance, the computing device 702 may carry out computer-readable instructions to perform each block of the processes described in Section B.

Alternatively, or in addition, the computing device 702 may rely on one or more other hardware logic components 712 to perform operations using a task-specific collection of logic gates. For instance, the hardware logic component(s) 712 may include a fixed configuration of hardware logic gates, e.g., that are created and set at the time of manufacture, and thereafter unalterable. Alternatively, or in addition, the other hardware logic component(s) 712 may include a collection of programmable hardware logic gates that can be set to perform different application-specific tasks. The latter category of devices includes, but is not limited to Programmable Array Logic Devices (PALs), Generic Array Logic Devices (GALs), Complex Programmable Logic Devices (CPLDs), Field-Programmable Gate Arrays (FPGAs), etc.

FIG. 7 generally indicates that hardware logic circuitry 714 corresponds to any combination of the hardware processor(s) 704, the computer-readable storage media 706, and/or the other hardware logic component(s) 712. That is, the computing device 702 can employ any combination of the hardware processor(s) 704 that execute machine-readable instructions provided in the computer-readable storage media 706, and/or one or more other hardware logic component(s) 712 that perform operations using a fixed and/or programmable collection of hardware logic gates.

In some cases (e.g., in the case in which the computing device 702 represents a user computing device), the computing device 702 also includes an input/output interface 716 for receiving various inputs (via input devices 718), and for providing various outputs (via output devices 720). Illustrative input devices include a keyboard device, a mouse input device, a touchscreen input device, a digitizing pad, one or more static image cameras, one or more video cameras, one or more depth camera systems, one or more microphones, a voice recognition mechanism, any movement detection mechanisms (e.g., accelerometers, gyroscopes, etc.), and so on. One particular output mechanism may include a display device 722 and an associated graphical user interface presentation (GUI) 724. The display device 722 may correspond to a liquid crystal display device, a light-emitting diode display (LED) device, a cathode ray tube device, a projection mechanism, etc. Other output devices include a printer, one or more speakers, a haptic output mechanism, an archival mechanism (for storing output information), and so on. The computing device 702 can also include one or more network interfaces 726 for exchanging data with other devices via one or more communication conduits 728. One or more communication buses 730 communicatively couple the above-described components together.

The communication conduit(s) 728 can be implemented in any manner, e.g., by a local area computer network, a wide area computer network (e.g., the Internet), point-to-point connections, etc., or any combination thereof. The communication conduit(s) 728 can include any combination of hardwired links, wireless links, routers, gateway functionality, name servers, etc., governed by any protocol or combination of protocols.

FIG. 7 shows the computing device 702 as being composed of a discrete collection of separate units. In some cases, the collection of units may correspond to discrete hardware units provided in a computing device chassis having any form factor. FIG. 7 shows illustrative form factors in its bottom portion. In other cases, the computing device 702 can include a hardware logic component that integrates the functions of two or more of the units shown in FIG. 1. For instance, the computing device 702 can include a system on a chip (SoC or SOC), corresponding to an integrated circuit that combines the functions of two or more of the units shown in FIG. 7.

The following summary provides a non-exhaustive set of illustrative aspects of the technology set forth herein.

According to a first aspect, one or more computing devices for processing a feature of a machine-consumable resource are described. The computing device(s) include hardware logic circuitry, the hardware logic circuitry corresponding to: (a) one or more hardware processors that perform operations by executing machine-readable instructions stored in a memory, and/or by (b) one or more other hardware logic components that perform operations using a task-specific collection of logic gates.

The operations include: receiving a description of the feature of the machine-consumable resource, the machine-consumable resource being hosted by a computing system; discovering, based on the description, a set of characteristics pertaining to the feature; and producing supplemental metadata based on the characteristics that have been discovered. The supplemental metadata includes one or more attributes, the producing operation being performed by an augmentation framework that includes at least one augmentation component, each augmentation component supplying a set of attributes that complement an identified consumption environment. The operations further include storing the supplemental metadata pertaining to the feature in a metadata data store. The supplemental metadata is linked in the computing system to the feature. Each set of attributes is used to control a user experience in an associated consumption environment.

According to a second aspect, the machine-consumable resource is one or more of: a database; and/or a service; and/or user interface-related information that is used to provide a consumer-side user interface presentation.

According to a third aspect, the feature that is described is one or more of: an entity associated with the machine-consumable resource; and/or an operation performed by the machine-consumable resource; and/or a description of a user interface element associated with the machine-consumable resource.

According to a fourth aspect, the operations further include installing the feature on the computing system that hosts the machine-consumable resource.

According to a fifth aspect, the description is expressed with reference to a source schema.

According to a sixth aspect, a consumption environment associated with an augmentation component is defined, at least in part, with reference to a consumption schema.

According to a seventh aspect, a consumption environment associated with an augmentation component is defined, at least in part, by a computing language that a client computing device uses to consume the feature.

According to an eighth aspect, an attribute provided by an augmentation component corresponds to a name associated with a type, or method, or property.

According to a ninth aspect, an attribute provided by an augmentation component describes a comment.

According to a tenth aspect, an attribute provided by an augmentation component describes a parameter validation operation or security provision.

According to an eleventh aspect, the operations further include updating the supplemental metadata for the feature in the metadata data store, the updating operation producing additional supplemental metadata.

According to a twelfth aspect, the updating operation is performed, at least in part, based on existing supplemental metadata provided in the metadata data store.

According to a thirteenth aspect, in a consuming process, the operations further include: receiving a message from a consumer that identifies use case characteristics of a particular consumption environment in which the consumer seeks to interact with the machine-consumable resource; determining, based on the use case characteristics, whether there is at least one set of attributes in the metadata data store that is appropriate for the particular consumption environment; retrieving the set(s) of attributes from the metadata data store if the determining operation returns an affirmative result; and using the set(s) of attributes to provide a user experience to the consumer that is appropriate for the particular consumption environment.

According to a fourteenth aspect, the using operation (of the thirteenth aspect) includes generating code based, at least in part, on the set(s) of attributes in conjunction with the feature. The code provides a mechanism by which the consumer interacts with the machine-consumable resource.

According to a fifteenth aspect, the using operation (of the thirteenth aspect) includes generating a user interface element based, at least in part, on the set(s) of attributes in conjunction the feature.

According to a sixteenth aspect (dependent on the fifteenth aspect), a retrieved attribute identifies a widget or input processing mechanism to be added to the user interface element.

According to a seventeenth aspect, a method is described for processing a feature of a machine-consumable resource. The method includes: receiving a description of the feature of the machine-consumable resource, the machine-consumable resource being hosted by a computing system; discovering, based on the description, a set of characteristics pertaining to the feature; and producing supplemental metadata based on the characteristics that have been discovered. The metadata includes one or more attributes, the producing operation being performed by an augmentation framework that includes at least one augmentation component, each augmentation component supplying a set of attributes that complement an identified consumption environment. The method further includes storing the supplemental metadata pertaining to the feature in a metadata data store. The supplemental metadata is linked in the computing system to the feature. Further, each set of attributes is used to control a user experience in an associated consumption environment. The method is performed by hardware logic circuitry, the hardware logic circuitry corresponding to: (a) one or more hardware processors that perform operations by executing machine-readable instructions stored in a memory, and/or by (b) one or more other hardware logic components that perform operations using a task-specific collection of logic gates.

According to an eighteenth aspect (dependent on the seventeenth aspect), the method further includes, in a consuming process: receiving a message from a consumer that identifies use case characteristics of a particular consumption environment in which the consumer seeks to interact with the machine-consumable resource; determining, based on the use case characteristics, whether there is at least one set of attributes in the metadata data store that is appropriate for the particular consumption environment; retrieving the set(s) of attributes from the metadata data store if the determining operation returns an affirmative result; and using the set(s) of attributes to provide a user experience to the consumer that is appropriate for the particular consumption environment.

According to a nineteenth aspect (dependent on the seventeenth aspect), the method further includes updating the supplemental metadata for the feature in the metadata data store, the updating operation producing additional supplemental metadata.

According to a twentieth aspect, a computer-readable storage medium is described for storing computer-readable instructions. The computer-readable instructions, when executed by one or more hardware processors, perform a method that includes: receiving a message from a consumer that identifies use case characteristics of a particular consumption environment in which the consumer seeks to interact with the machine-consumable resource; and determining, based on the use case characteristics, whether there is at least one set of attributes in a metadata data store that is appropriate for the particular consumption environment. Each set of attributes in the metadata data store is produced, prior to receiving the message, by an augmentation component. And each set of attributes complements an identified consumption environment. The method further includes retrieving the set(s) of metadata from the metadata data store if the determining operation returns an affirmative result; and using the set(s) of metadata to provide a user experience to the consumer that is appropriate for the particular consumption environment.

A twenty-first aspect corresponds to any combination (e.g., any permutation or subset that is not logically inconsistent) of the above-referenced first through twentieth aspects.

A twenty-second aspect corresponds to any method counterpart, device counterpart, system counterpart, means-plus-function counterpart, computer-readable storage medium counterpart, data structure counterpart, article of manufacture counterpart, graphical user interface presentation counterpart, etc. associated with the first through twenty-first aspects.

In closing, the functionality described herein can employ various mechanisms to ensure that any user data is handled in a manner that conforms to applicable laws, social norms, and the expectations and preferences of individual users. For example, the functionality can allow a user to expressly opt in to (and then expressly opt out of) the provisions of the functionality. The functionality can also provide suitable security mechanisms to ensure the privacy of the user data (such as data-sanitizing mechanisms, encryption mechanisms, password-protection mechanisms, etc.).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computing devices for processing a feature of a machine-consumable resource:
hardware logic circuitry, the hardware logic circuitry corresponding to: (a) one or more hardware processors that perform operations by executing machine-readable instructions stored in a memory, and/or by (b) one or more other hardware logic components that perform operations using a task-specific collection of logic gates, the operations including:
receiving a description of the feature of the machine-consumable resource, the machine-consumable resource being hosted by a computing system;
discovering, based on the description, a set of characteristics pertaining to the feature;
producing supplemental metadata based on the characteristics that have been discovered, the supplemental metadata including one or more attributes, said producing being performed by an augmentation framework that includes at least one augmentation component, each augmentation component supplying a set of attributes that complement an identified consumption environment; and
storing the supplemental metadata pertaining to the feature in a metadata data store, the supplemental metadata being linked in the computing system to the feature, p1 each set of attributes being used to control a user experience in an associated consumption environment.

2. The one or more computing devices of claim 1, wherein the machine-consumable resource is one or more of:
a database; and/or
a service; and/or
user interface-related information that is used to provide a consumer-side user interface presentation.

3. The one or more computing devices of claim 1, wherein the feature that is described is one or more of:
an entity associated with the machine-consumable resource; and/or
an operation performed by the machine-consumable resource; and/or
a description of a user interface element associated with the machine-consumable resource.

4. (canceled)

5. (canceled)

6. (canceled)

7. The one or more computing devices of claim 1, wherein a consumption environment associated with an augmentation component is defined, at least in part, by a computing language that a client computing device uses to consume the feature.

8. The one or more computing devices of claim 1, wherein an attribute provided by an augmentation component corresponds to a name associated with a type, or method, or property.

9. The one or more computing devices of claim 1, wherein an attribute provided by an augmentation component describes a comment.

10. The one or more computing devices of claim 1, wherein an attribute provided by an augmentation component describes a parameter validation operation or security provision.

11. The one or more computing devices of claim 1, wherein the operations further comprise updating the supplemental metadata for the feature in the metadata data store, said updating producing additional supplemental metadata.

12. The one or more computing devices of claim 11, wherein said updating is performed, at least in part, based on existing supplemental metadata provided in the metadata data store.

13. The one or more computing devices of claim 1, wherein, in a consuming process, the operations further include:
receiving a message from a consumer that identifies use case characteristics of a particular consumption environment in which the consumer seeks to interact with the machine-consumable resource;
determining, based on the use case characteristics, whether there is at least one set of attributes in the metadata data store that is appropriate for the particular consumption environment;
retrieving said at least one set of attributes from the metadata data store if said determining returns an affirmative result; and
using said at least one set of attributes to provide a user experience to the consumer that is appropriate for the particular consumption environment.

14. The one or more computing devices of claim 13,
wherein said using includes generating code based, at least in part, on said at least one set of attributes in conjunction with the feature,
the code providing a mechanism by which the consumer interacts with the machine-consumable resource.

15. The one or more computing devices of claim 13, wherein said using includes generating a user interface element based, at least in part, on said at least one set of attributes in conjunction the feature.

16. The one or more computing devices of claim 15, wherein a retrieved attribute identifies a widget or input processing mechanism to be added to the user interface element.

17. A method for processing a feature of a machine-consumable resource, comprising:
receiving a description of the feature of the machine-consumable resource, the machine-consumable resource being hosted by a computing system;
discovering, based on the description, a set of characteristics pertaining to the feature;
producing supplemental metadata based on the characteristics that have been discovered, the metadata including one or more attributes, said producing being performed by an augmentation framework that includes at least one augmentation component, each augmentation component supplying a set of attributes that complement an identified consumption environment; and
storing the supplemental metadata pertaining to the feature in a metadata data store, the supplemental metadata being linked in the computing system to the feature,
each set of attributes being used to control a user experience in an associated consumption environment,
the method being performed by hardware logic circuitry, the hardware logic circuitry corresponding to: (a) one or more hardware processors that perform operations by executing machine-readable instructions stored in a memory, and/or by (b) one or more other hardware logic components that perform operations using a task-specific collection of logic gates.

18. The method of claim 17, further comprising, in a consuming process:
receiving a message from a consumer that identifies use case characteristics of a particular consumption environment in which the consumer seeks to interact with the machine-consumable resource;
determining, based on the use case characteristics, whether there is at least one set of attributes in the metadata data store that is appropriate for the particular consumption environment;
retrieving said at least one set of attributes from the metadata data store if said determining returns an affirmative result; and
using said at least one set of attributes to provide a user experience to the consumer that is appropriate for the particular consumption environment.

19. The method of claim 17, further comprising updating the supplemental metadata for the feature in the metadata data store, said updating producing additional supplemental metadata.

20. A computer-readable storage medium for storing computer-readable instructions, the computer-readable instructions, when executed by one or more hardware processors, performing a method that comprises:
receiving a message from a consumer that identifies use case characteristics of a particular consumption environment in which the consumer seeks to interact with the machine-consumable resource;
determining, based on the use case characteristics, whether there is at least one set of attributes in a metadata data store that is appropriate for the particular consumption environment,
each set of attributes in the metadata data store being produced, prior to receiving said message, by an augmentation component, and
each set of attributes complementing an identified consumption environment;
retrieving said at least one set of metadata from the metadata data store if said determining returns an affirmative result; and
using said at least one set of metadata to provide a user experience to the consumer that is appropriate for the particular consumption environment.

21. The one or more computing devices of claim 1, wherein the operations are performed as a part of a process of installing the feature in the machine-consumable resource.

22. The one or more computing devices of claim 1, wherein said producing preserves metadata that is lost in a process of installing the feature in the machine-consumable resource.

23. The one or more computing devices of claim 11, wherein the updating is performed when a new consumption environment is identified or an existing consumption environment is modified.

24. The one or more computing devices of claim 13, wherein said determining selects a set of attributes that most closely matches the characteristic of the particular consumption environment when there are two or more sets of attributes that match the particular consumption environment.

25. The one or more computing devices of claim 13, wherein said at least one set of attributes corresponds to two or more sets of attributes pertaining to different respective aspects of the particular consumption environment.

26. The one or more computing devices of claim 13, wherein the operations further comprise invoking a default resource-consuming process when said determining finds no appropriate set of attributes, the default resource-consuming process operating on information pertaining to the machine-consumable resource that is independent of the supplemental metadata

27. The one or more computing devices of claim 13, wherein said using includes using a component that is specific to the particular consumption environment to provide the user experience.
